(19) United States
(12) Patent Application Publication
(10) Pub. No.: US 2025/0381766 A1
(43) Pub. Date: Dec. 18, 2025

(54) BIAXIALLY ORIENTED FORMABLE SEALABLE AND NON-SEALABLE FILM AND PROCESS FOR PREPARING THEREOF

(71) Applicant: ESTER INDUSTRIES LIMITED, Khatima (IN)

(72) Inventors: GIRISH BEHAL, Gurugram (IN); VINOD SINGH KANYAL, Khatima (IN); SHAILENDRA YADAV, Gurugram (IN); SAROJ KUMAR, Khatima (IN); GOURAV OJHA, Khatima (IN)

(21) Appl. No.: 18/878,468

(22) PCT Filed: Mar. 7, 2023
(86) PCT No.: PCT/IN2023/050218

§ 371 Date: Dec. 23, 2024

(30) Foreign Application Priority Data
Jan. 12, 2023 (IN) 202311002459

(51) Int. Cl. B32B 27/36; B29C 48/00; B29C 48/08; B29C 48/21; B29C 55/14; B29K 67/00; B32B 27/08; C08G 63/183

(52) U.S. Cl. CPC B32B 27/36; B32B 27/08; C08G 63/183; B29C 48/0018; B29C 48/08; B29C 48/21; B29C 55/143; B29K 2067/003; B32B 2250/03; B32B 2250/244; B32B 2307/31; B32B 2307/518; B32B 2307/7376

(57) ABSTRACT

The present invention relates to a biaxially oriented sealable and non-sealable polyester film of multilayer structure B/B/A comprising: (a) an outer layer B; (b) a middle layer B; and (c) an inner layer A. The present invention also relates to a process for preparing the biaxially oriented sealable polyester film as described herein. The biaxially oriented and non-sealable flexible polyester film of the present invention an enhanced mechanical properties i.e. tensile, elongation, dart impact, tear resistance, with better drawability, high temperature stability and high seal strength low seal initiation temperature.

### FIELD OF INVENTION

The present invention relates to a formable flexible sealable and non-sealable transparent biaxially oriented polyester film. Particularly, the present invention relates to a biaxially oriented sealable and non-sealable polyester film of multilayer structure B/B/A having characteristic of a high seal strength, good cold and thermoformability properties with high temperature dimensional stability. The invention also relates to a process for preparing the biaxially oriented sealable and non-sealable polyester film as described herein.

### BACKGROUND OF INVENTION

The multilayer films or laminates are used to package articles such as food products, electronics item, or pharmaceuticals in multilayer films or laminates to protect these packaged articles from mishandle and outward contamination. Formable films are well known in the industry for the packaging of foodstuff, blister packaging, medical products, electronic items and industrial goods. These formable films used for packing articles provide better printability, drawability, barrier properties, clarity, mechanical properties, flame retardant, and resistance to ultraviolet (UV). The formable films offer cost-effective packaging and easy handling of packaged material, and ensure safe transportation and delivery to an end user.

Forming is the process of transforming single layer films, multilayer films, mono material laminates, multi material laminates or sheets etc., to the desired shape of moulds by either pressure moulding or vacuum forming technology. The simplest thermoforming process consists of heating a sheet of plastic to its forming temperature and mechanically forcing it against a cooled solid shape called a mold. There are many variations and improvements of this simple thermoforming process. Such variations are employed in heavy-gauge thermoforming than in light-gauge thermoforming process, and primary reason for this is that thicker sheet retains its formable temperature longer. This allows for more manipulation of hot sheet before it is forced against a mold surface. During the process, heat is lost very quickly from thin sheet and as a result, thin sheet is formed quicker. Therefore, the films produced from the processes known in the art, have a normal thickness range i.e., 8 to 75 μ. Moreover, these conventional films are produced with pigments, such as, silicon dioxide, UV master batch, polyester chips, and combinations thereof. These films are produced by sequential biaxial orientation extrusion process.

Cold and thermoformable films are well known in the art and are found in a multiplicity of different applications. The films are known for ready to shapability (drawing) under hot and cold conditions, in case of vacuum forming or compressed-air forming or of mechanical action using dies. Typical film materials for forming are polyvinylchloride (PVC), polystyrene (PS), polypropylene (PP), and especially polycarbonate (PC). Further, multi-layer film systems (PS/ethylene vinyl alcohol (EVOH)/polyethylene (PE) or PP/EVOH/PE, and PE/EVOH/PE), are often employed in foods packaging applications, as such systems are known to have better heat-sealing properties or vapour barriers for improved keeping properties. Typical fields of application for forming films are meat or poultry, blisters, hard-shell cases, furniture or metal lamination (can liners).

For instance, reference is made to US 2021/0301126 A1, which consists of a biaxially oriented formable polyethylene terephthalate (PET) films that are capable of thermoforming or cold-forming having multilayer layer A/B/A structure. The film comprises at least two outer layer A. The disclosed film is capable of thermoforming above its glass transition temperature (Tg) and below its melting temperature (Tm) and capable of cold forming at ambient temperature and pressure conditions.

Further reference is made to U.S. Pat. No. 11,041,056 B2, which describes a transparent, biaxially oriented, thermoformable polyester film including at least 85% by weight of a co-polyester whose dicarboxylic acid components derive to an extent of 85 to 94 mol % from terephthalic acid-based units and to an extent of 6 to 15 mol % from isophthalic acid-based units.

Another reference is made to 2021/0395446 A1, which relates to crystallizable shrinkable films and thermoformable film(s) or sheet(s) comprising blends of polyester compositions comprising residues of terephthalic acid, neopentyl glycol (NRG), 1,4-cyclohexanedimethanol (CHDM), ethylene glycol (EG), and diethylene glycol (DEG), in certain compositional ranges having certain advantages and improved properties. However, the film disclosed therein are not suitable for high temperature applications, as these films suffers from high shrinkage which produces more wastage.

Yet another reference is made to US 2021/0292076 A1, which comprises a package with a laminate having the following substantially coextensive layers in the following order (a) a non-sealable, self-supporting, thermoformable copolyester film layer having a first surface and a second surface, said second surface constituting an outermost, exposed surface of the laminate; (b) a laminating adhesive layer on the first surface of the thermoformable copolyester film layer; and (c) a self-supporting, thermoformable structural film layer having a first surface and a second surface, said first surface contacting the laminating adhesive layer. However, the films disclosed therein comprises laminate of two different type of polymeric films, which are non-recyclable.

Although various efforts have been made to deploy the biaxially oriented PET films in the packaging application, however, these conventional formable biaxially oriented PET films and methods to prepare the said films, includes the ones as described above, suffer from major drawbacks such as: (a) Barrier properties and mechanical strength; (b) non-sealable; (c) Do not exhibit good dimensional stability; (d) Do not provide mono-family multilayer laminate like Printed PET Film/Adhesive/Invented Sealable Film.

Accordingly, there is a dire need in the art to provide formable films that consists with combination of following desirable properties, such as high mechanical strength (e.g. Tensile, toughness and elongation), better optical properties; balance shrinkage at elevated temperature in longitudinal and machine directions, high temperature dimensional stability, puncture resistance; dart Impact strength, better drawability, cost-effective, better barrier properties, high seal strength with low seal initiation temperature; and having ability to replace multilayered laminate with improved barrier properties.

### OBJECTS OF THE INVENTION

The principal object of present invention is to provide a biaxially oriented Formable sealable and non-sealable film of multilayer structure B/B/A.

Another object of the present invention is to provide a process for preparing the biaxially oriented sealable and non-sealable film as described herein.

### SUMMARY OF THE INVENTION

The present invention discloses a biaxially oriented sealable and non-sealable film of multilayer structure B/B/A comprising: (a) an outer layer B; (b) a middle layer B; and (c) an inner layer A, wherein the outer and the middle layer B comprises at least one filler, at least one thermoplastic polyethylene terephthalate (PET) polymer, and at least one modified thermoplastic polyethylene terephthalate (PET) polymer, and wherein the inner layer A comprises at least one component selected from the group consisting of at least one filler, at least one thermoplastic polyethylene terephthalate (PET) polymer, MBUV polymer, SH3-M polymer, and combination thereof. The present invention also discloses a cost-effective process for preparing the biaxially oriented sealable and non-sealable film as described herein. The biaxially oriented polyester film as described herein has high seal strength with low seal initiation temperature and exhibits high mechanical strength, optical properties, drawability (shaping), high temperature stability.

### DESCRIPTION OF ACCOMPANYING FIGURES

The accompanying drawings constitute a part of the description and are used to provide further understanding of the present invention. Such accompanying drawings illustrate the embodiments of the present invention, which are used to describe the principles of the present invention together with the description.

FIG. 1 depicts structural view of biaxially oriented non sealable polyester film of multilayer structure B/B/A as described in Examples 1 and 2 of the present invention, in accordance with an implementation of the present invention.

FIG. 2 depicts structural view of biaxially oriented sealable polyester film of multilayer structure B/B/A as described in Example 3 of the present invention, in accordance with an implementation of the present invention.

FIG. 3 depicts the films conventionally known in the prior arts, in accordance with an implementation of the present invention.

FIG. 4 depicts laminate structure comprising the films of the present invention (a) High barrier laminate; (b) High barrier Aluminum foil based laminate; and (c) Mono layer sustainable film structure (d) Sustainable mono-family multilayer laminate for packaging, in accordance with an implementation of the present invention.

### DETAILED DESCRIPTION OF THE INVENTION:

While the invention is susceptible to various modifications and alternative forms, specific embodiment thereof will be described in detail below. It should be understood, however that it is not intended to limit the invention to the particular forms disclosed, but on the contrary, the invention is to cover all modifications, equivalents, and alternative falling within the scope of the invention as defined by the appended claims.

Although one or more features and/or elements may be described herein in the context of only a single embodiment, or alternatively in the context of more than one embodiment, or further alternatively in the context of all embodiments, the features and/or elements may instead be provided separately or in any appropriate combination or not at all. Conversely, any features and/or elements described in the context of separate embodiments may alternatively be realized as existing together in the context of a single embodiment.

The terminology used herein is for the purpose of describing particular various embodiments only and is not intended to be limiting of various embodiments. As used herein, the singular forms “a,” “an” and “the” are intended to include the plural forms as well, unless the context clearly indicates otherwise.

The term “biaxially oriented formable sealable polyester film” refers to a film stretched in both machine and transverse directions, producing molecular chain orientation in two directions. The film of the present invention are “flexible formable films” which means that the film can be thermoformed and cold formed with the better flexibility or without losing properties on commercially available thermoforming or cold forming machines.

The term “thermoforming” and variations thereof as used herein refer to pressure forming, vacuum forming, matched die forming.

The term “cold-forming” and variations thereof as used herein refer to drawing without being subjected to heat.

The term “sealable film” refers to a film having a high seal strength that can be used as single layer pouch or within laminate as sealant layer.

The term “fillers” refers to an inorganic material that are added to a polymer to enhance their mechanical and functional properties.

The term “modified thermoplastic polyethylene terephthalate (PET) polymer” refers to a PET polymer whose properties are modified. The composition of modified PET polymer comprises a combination of pure terephthalic acid (PTA), ethylene glycol (EG), and DEG (diethylene glycol). The presence of modified PET polymer is important for improving the percentage of elongation and other functional properties of the film of the present invention.

The term “UV resistance master batch (MBUV) polymer” refers to a polymer comprising a mixture of 75-85% PET polymer and 15-25% of premix, wherein premix is mixture of UV absorber and antioxidant.

The term “heat sealable master batch or SH3-M” polymer refers to a polymer which is a blend of 70-90% of PET, and 10-30% of isophthalic acid (IPA).

The term “dart impact resistance” refers to an ability of the film of the present invention to absorb shock with high magnitude.

The term “low seal initiation temperature” means the lowest temperature at which specific level of seal strength is obtained.

As used herein, the term “forming” is a process of transforming single layer films, multilayer films, mono material laminates, multi material laminates or sheets etc. to the desired shape of moulds either by pressure moulding or vacuum forming technology.

As discussed in the background section of the present invention, the conventional biaxially oriented PET films suffer from major drawbacks such as uniform draw in hot or cold forming process and dimensional stability.

In order to overcome the aforementioned problems, the present invention provides a biaxially oriented sealable polyester film of multilayer structure B/B/A having desired set of properties, such as, high mechanical strength, drawability, high temperature stability, balance shrinkage, barrier properties as well and high seal strength with low seal initiation properties etc. The sealable films of the present invention is notable in particular for having good cold and thermoformability, and for having superior barrier after formation and heat sealability properties as well. Moreover, the film of the present invention also exhibits brilliant optical properties in particular a high clarity with haze less than 1.5% and gloss greater than 120 and clarity higher than 88%.

In particular, the present invention discloses a biaxially oriented sealable and non-sealable polyester film of multilayer structure B/B/A comprising: (i) an outer layer B; (ii) a middle layer B; and (iii) an inner layer A, wherein the outer and the middle layer B comprises at least one filler, at least one thermoplastic polyethylene terephthalate (PET) polymer, and at least one modified thermoplastic polyethylene terephthalate (PET) polymer, and wherein the inner layer A comprises at least one component selected from the group consisting of at least one filler, at least one thermoplastic polyethylene terephthalate (PET) polymer, MBUV polymer, SH3-M polymer, and combination thereof. The presence of modified thermoplastic polyethylene terephthalate (PET) polymer and filler like silica, are crucial for obtaining the film having the desired functional properties in terms of friction and sealability, and better mechanical properties. Further, in absence of any of the layer (B/B/A) from the film, the functional and mechanical properties of the film are affected. Among the good mechanical properties of the film are a high tensile strength values more than 1300-1500 Kg/cm² in longitudinal direction (MD); more than 1400-1750 Kg/cm² in transverse direction (TD). The film also has excellence elongation properties in longitudinal direction (MD) and transverse direction (TD), which is in the range of 140 to 200 and 130 to 180, respectively. The film also has an excellent seal strength in the range of 0.8 to 1.4 kg/cm² with low seal initiation temperature in the range of 90° C.-100° C. The film also shows better resistance to moisture and oxygen transmission rate. The film has a thickness in the range of 8 μ to 75 μ. Apart from the above properties, the film has the following properties as well: (i) excellence dart impact resistance (means having ability to absorb shock with high magnitude) in the range of 220-850 gf; (ii) Puncture resistance in the range of 6-9 N; (iii) Glass transition and melting temperature (Tg) and (Tm) value of 78.2-78.7 and 246.9-247.8, respectively; (iv) Seal initiation temperature in the range of 90-100° C. The presence of modified PET polymer is crucial for arriving at the film that exhibits drawability in the range of 10-17 mm and exhibits enhanced structural and functional properties as compared to film without any modified PET polymer.

15 The film of the present invention characterized with a high-transparency has a low degree of filling (i.e., less concentration of anti-blocking agent, i.e., silica), as a result of which the film of the present invention has good winding and processing qualities. During winding and unwinding of the film, individual plies of film may not adhere to one another, not even at elevated temperature, e.g. 40 or 50° C.

The present invention also discloses a cost-effective process for preparing the biaxially oriented sealable and non-sealable polyester film of multilayer structure B/B/A having good longitudinal and transverse orientability, resistance to UV, high temperature dimensional stability and excellent heat seal strength with low seal initiation temperature. The dimension stability of the film provide uniform thickness cavity during film formation.

Owing to the cold forming and thermoforming properties of the film, the film of the present invention is used in packaging applications, wherein the films are shaped in the desired packing design by applying pressure on mould at an ambient temperature by cold forming and thermoforming process performed above than glass transition temperature and below its melting temperature. The thermoforming is done in the film upto a depth of 10-20 mm. Due to the high seal strength, the films of the present invention can be used as a single layer pouch or within laminate as a sealant layer. Thus, the biaxially oriented sealable and non-sealable polyester film of multilayer structure B/B/A are particularly useful for pharma-packaging application, more particularly, blister packaging such as for capsules, tablets, ideal for deli meats, cuts of meat, poultry or fish, or dry products such as wrappers, fresh proteins, frozen foods, sliced cheese packaging ideal for syringes, tablet packaging, dental kits and more as such or in laminate structure. Preferably, the biaxially oriented sealable and non-sealable polyester film are particularly useful for food packaging application as such or in laminate structure. The film of the present invention are also use full for single layer sustainable packaging or manufacturing sustainable recyclable laminate with another polyester film.

The biaxially oriented sealable and non-sealable polyester film of multilayer structure B/B/A can also be coated with polymeric material selected from polyvinyl alcohol (PVOH)/ethylene vinyl alcohol (EVOH)/polyvinylidene dichloride (PVDC) to improve barrier properties as per product requirement. Films are also optionally coated with adhesion promoter or functional polymeric coatings (acrylic primer coatings). High seal strength means film can be used as single layer pouch or within laminate as sealant layer to replace sealable Biaxially Oriented PolyPropylene Films/Blown Polyethylene film/Cast Polypropylene Films (BOPP/PE/CPP/). The films of the present invention are also able to replace biaxially oriented nylon film and PVC films for cavity draw.

The biaxially oriented sealable and non-sealable polyester film of multilayer structure B/B/A can moreover be recycled without contaminating the environment. Thus, the film of the present invention from the recycled or virgin material exhibits practically no impairment mechanical and other properties when compared with a film produced from virgin PET materials. The film of the present invention further comprises UV stabilizers, i.e. light stabilizers that are UV absorbers.

In an embodiment of the present disclosure, there is provided a biaxially oriented sealable and non-sealable polyester film of multilayer structure B/B/A comprising: (i) an outer layer B; (ii) a middle layer B; and (iii) an inner layer A, wherein the outer and the middle layer B comprises at least one filler, at least one thermoplastic polyethylene terephthalate (PET) polymer, and at least one modified thermoplastic polyethylene terephthalate (PET) polymer, and wherein the inner layer A comprises at least one component selected from the group consisting of at least one filler, at least one thermoplastic polyethylene terephthalate (PET) polymer, MBUV polymer, SH3-M polymer, and combination thereof.

In an embodiment of the present invention, there is provided a biaxially orientated sealable and non-sealable film as described herein, wherein the thermoplastic polyethylene terephthalate (PET) polymer has a combined weight percentage in the range of 55 to 75% with respect to the film. In another embodiment of the present invention, the thermoplastic polyethylene terephthalate (PET) polymer has a combined weight percentage in the range of 58 to 73% with respect to the film. In yet another embodiment of present invention, the thermoplastic polyethylene terephthalate (PET) polymer has a combined weight percentage in the range of 60 to 70% with respect to the film. In one another embodiment of the present invention, the thermoplastic polyethylene terephthalate (PET) polymer has a combined weight percentage in the range of 63 to 68% with respect to the film.

In an embodiment of the present invention, there is provided a biaxially orientated sealable and non-sealable film as described herein, wherein the modified PET polymer has a weight percentage in the range of 30 to 45% with respect to the film. In another embodiment of the present invention, the modified PET polymer has a weight percentage in 20 the range of 32 to 43% with respect to the film. In yet another embodiment of the present invention, the modified PET polymer has a weight percentage in the range of 35 to 40% with respect to the film. In one another embodiment of the present invention, the modified PET polymer has a weight percentage in the range of 38 to 40% with respect to the film.

In an embodiment of the present invention, there is provided a biaxially orientated sealable and non-sealable film as described herein, wherein the filler has a combined weight percentage in the range of 0.03 to 0.08% is selected from silica. In another embodiment of the present invention, the filler has a combined weight percentage in the range of 0.04 to 0.07%. In yet another embodiment of the present invention, the filler has a combined weight percentage in the range of 0.05 to 0.07%.

In an embodiment of the present invention, there is provided a biaxially oriented sealable and non-sealable polyester film of multilayer structure B/B/A comprising: (i) an outer layer B; (ii) a middle layer B; and (iii) an inner layer A, wherein the outer and the middle layer B comprises at least one filler, at least one thermoplastic polyethylene terephthalate (PET) polymer, and at least one modified thermoplastic polyethylene terephthalate (PET) polymer, and wherein the inner layer A comprises at least one component selected from the group consisting of at least one filler, at least one thermoplastic polyethylene terephthalate (PET) polymer, MBUV polymer, SH3-M polymer, and combination thereof, wherein the thermoplastic polyethylene terephthalate (PET) polymer has a combined weight percentage in the range of 55 to 75% with respect to the film, and wherein the modified PET polymer has a weight percentage in the range of 30 to 45% with respect to the film, and wherein the filler having a combined weight percentage in the range of 0.03 to 0.08% is selected from silica.

In an embodiment of the present invention, there is provided a biaxially orientated sealable and non-sealable film as described herein, wherein the MBUV polymer having a weight percentage in the range of 0.5 to 2% with respect to the film, comprises 75-85% of PET polymer and 15-25% of a premix comprising a blend of UV absorber and antioxidant. In another embodiment of the present invention, MBUV polymer has a weight percentage in the range of 0.7 to 1.5% with respect to the film. In yet another embodiment of the present invention, MBUV polymer has a weight percentage in the range of 0.8 to 1.2% with respect to the film.

In an embodiment of the present invention, there is provided a biaxially orientated film as described herein, wherein SH3-M polymer has a weight percentage in the range of 10 to 30%. In another embodiment of the present invention, SH3-M polymer has a weight percentage in the range of 12 to 28%, or 15 to 25%, or 18 to 22%, wherein SH3-M polymer comprises a blend of 70-90% of PET, and 10-30% of isophthalic acid (IPA).

In an embodiment of the present invention, there is provided a biaxially orientated sealable and non-sealable film as described herein, wherein the thermoplastic polyethylene terephthalate (PET) polymer comprises: (i) 70 to 80% of purified terephthalic acid (PTA); (ii) 20 to 30% of ethylene glycol (EG); and (iii) 1 to 2% of diethylene glycol. In another embodiment of the present invention, the thermoplastic polyethylene terephthalate (PET) polymer comprises: (i) 72 to 75% of purified terephthalic acid (PTA); (ii) 22 to27% of ethylene glycol (EG); and (iii) 1.2 to 2% of diethylene glycol.

In an embodiment of the present invention, there is provided a biaxially orientated sealable and non-sealable film as described herein, wherein the modified PET polymer comprises: (i) 65 to 85% of purified terephthalic acid (PTA); (ii) 20 to 30% of ethylene glycol (EG); and (iii) 4 to 10% of diethylene glycol. In another embodiment of the present invention, the modified PET polymer comprises: (i) 68 to 82% of purified terephthalic acid (PTA); (ii) 22 to 27% of ethylene glycol (EG); and (iii) 5 to 9% of diethylene glycol.

In an embodiment of the present invention, there is provided a biaxially oriented sealable and non-sealable polyester film of multilayer structure B/B/A comprising: (i) an outer layer B; (ii) a middle layer B; and (iii) an inner layer A, wherein the outer and the middle layer B comprises at least one filler, at least one thermoplastic polyethylene 15 terephthalate (PET) polymer, and at least one modified thermoplastic polyethylene terephthalate (PET) polymer, and wherein the inner layer A comprises at least one component selected from the group consisting of at least one filler, at least one thermoplastic polyethylene terephthalate (PET) polymer, MBUV polymer, and combination thereof, wherein the thermoplastic polyethylene terephthalate (PET) polymer has a combined weight 20 percentage in the range of 55 to 75% with respect to the film, and wherein the modified PET polymer has a weight percentage in the range of 30 to 45% with respect to the film, and wherein the filler having a combined weight percentage in the range of 0.03 to 0.08% is selected from silica, and wherein the MBUV polymer having a weight percentage in the range of 0.5 to 2% with respect to the film, comprises polymer and a premix.

In an embodiment of the present invention, there is provided a biaxially oriented sealable and non-sealable polyester film of multilayer structure B/B/A comprising: (i) an outer layer B; (ii) a middle layer B; and (iii) an inner layer A, wherein the outer and the middle layer B comprises at least one filler, at least one thermoplastic polyethylene terephthalate (PET) polymer, and at least one modified thermoplastic polyethylene terephthalate (PET) polymer, and wherein the inner layer A comprises SH3-M, wherein the thermoplastic polyethylene terephthalate (PET) polymer has a combined weight percentage in the range of 55 to 75% with respect to the film, and wherein the modified PET polymer has a weight percentage in the range of 30 to 45% with respect to the film, and wherein the filler having a combined weight percentage in the range of 0.03 to 0.08% is selected from silica, wherein SH3-M polymer has a weight percentage in the range of 10 to 30%.

In an embodiment of the present invention, there is provided a biaxially oriented sealable and non-sealable polyester film of multilayer structure B/B/A comprising: (i) an outer layer B; (ii) a middle layer B; and (iii) an inner layer A, wherein the outer and the middle layer B comprises at least one filler, at least one thermoplastic polyethylene terephthalate (PET) polymer, and at least one modified thermoplastic polyethylene terephthalate (PET) polymer, and wherein the inner layer A comprises at least one component selected from the group consisting of at least one filler, at least one thermoplastic polyethylene terephthalate (PET) polymer, MBUV polymer, and combination thereof, wherein the thermoplastic polyethylene terephthalate (PET) polymer having a combined weight percentage in the range of 55 to 75% with respect to the film comprises: (a) 70 to 80% of purified terephthalic acid (PTA); (b) 20 to 30% of ethylene glycol (EG); and (c) 1to 2% of diethylene glycol (DEG), and wherein the modified PET polymer having a weight percentage in the range of 30 to 45% with respect to the film comprises: (a) 65 to 85% of purified terephthalic acid (PTA); (b) 20 to 30% of ethylene glycol (EG); and (c) 4 to 10% of diethylene glycol (DEG), and wherein the filler having a combined weight percentage in the range of 0.03 to 0.08% is selected from silica, and wherein the MBUV polymer having a weight percentage in the range of 0.5 to 2% with respect to the film, comprises polymer and a premix.

In an embodiment of the present invention, there is provided a biaxially oriented sealable and non-sealable polyester film of multilayer structure B/B/A comprising: (i) an outer layer B; (ii) a middle layer B; and (iii) an inner layer A, wherein the outer and the middle layer B comprises at least one filler, at least one thermoplastic polyethylene terephthalate (PET) polymer, and at least one modified thermoplastic polyethylene terephthalate (PET) polymer, and wherein the inner layer A comprises SH3-M, wherein the 30 thermoplastic polyethylene terephthalate (PET) polymer having a combined weight percentage in the range of 55 to 75% with respect to the film comprises: (a) 70 to 80% of purified terephthalic acid (PTA); (b) 20 to 30% of ethylene glycol (EG); and (c) 1 to 2% of diethylene glycol (DEG), and wherein the modified PET polymer having a weight percentage in the range of 30 to 45% with respect to the film comprises: (a) 65 to 85% of purified terephthalic acid (PTA); (b) 20 to 30% of ethylene glycol (EG); and (c) 4 to 10% of diethylene glycol (DEG), and wherein the filler having a combined weight percentage in the range of 0.03 to 0.08% is selected from silica, wherein SH3-M polymer has a weight percentage in the range of 10 to 30%.

In an embodiment of the present invention, there is provided a biaxially orientated sealable and non-sealable film as described herein, wherein the film has a thickness in the range of 8 to 75 μ. In another embodiment of the present invention, the film has a thickness in the range of 10 to 70 μ, or 15 to 65 μ, or 20 to 60 μ, or 25 to 55 μ, or 30 to 50 μ, or 35 to 45 μ.

In an embodiment of the present invention, there is provided a biaxially oriented sealable and non-sealable film as described herein, wherein the film has a percentage of elongation in the range of 150 to 200 and 135 to 180 in longitudinal direction and transverse direction, respectively. In another embodiment of the present invention, the film has a percentage of elongation in the range of 160 to 190 and 140 to 170 in longitudinal direction and transverse direction, respectively. In yet another embodiment of the present invention, the film has a percentage of elongation in the range of 170 to 180 and 150 to 160 in longitudinal direction and transverse direction, respectively.

In an embodiment, there is provided a process for preparing a biaxially oriented sealable and non-sealable film as described herein, said process comprising: (i) feeding at least one filler, at least one thermoplastic polyethylene terephthalate (PET) polymer, at least one modified thermoplastic polyethylene terephthalate (PET) polymer into an extruder at a temperature in the range of 255-278° C. to obtain a first mixture; (ii) co-feeding at least one member into a co-extruder at a temperature in the 265-280° C. to obtain a second mixture, wherein the at least one member is selected from the group consisting of at least one filler, at least one thermoplastic polyethylene terephthalate (PET) polymer, MBUV polymer, SH3-M polymer, and combination thereof; (iii) laminating the first mixture of step (a) and the second mixture of step (b) in an extrusion die to produce a laminated molten structure; (iv) extruding the laminated molten structure of step (c) from a slit die, followed by its quenching to produce a film having multilayered structure as B/B/A; (v) stretching the film of step (d) in longitudinal direction at a temperature in the range of 80-95° C. to produce a longitudinal oriented film; (vi) stretching the longitudinal oriented film of step (e) in transverse direction at a temperature in the range of 110-190° C. to prepare the biaxially oriented film; and (vii) drawability in the range of 10-17 mm.

In an embodiment of the present invention, there is provided an article comprising the biaxially oriented film as described herein, wherein the article is selected from the group consisting of sustainable recyclable laminates pouches, packaging material for pharma- packaging application, and blister packaging application.

The present invention is illustrated hereunder in greater detail in relation to non- limiting exemplary embodiments as per the following examples:

### EXAMPLES

The following examples are put forth so as to provide those of ordinary skill in the art with a complete disclosure and the description of how to make and use the present invention, and are not intended to limit the scope of what the inventors regard as their invention nor are they intended to represent that the experiments below are all and only experiments performed. The methodology of preparing few of the preferred embodiments shall become clearer with working examples provided below.

The forthcoming examples describes the biaxially oriented sealable and non-sealable films produced according to the process of the present invention, wherein the film has B/B/A layered structure which comprises a combination of polyethylene terephthalate, modified polyethylene terephthalate and silica as filler. The thickness of the film of the present invention was 12, 23, and 36 μm. The layer B comprises 85% of total layer thickness, whereas, layer A comprises 15% of total layer thickness. The film having a correct orientation of B/B/A, and the presence of a modified PET polymer and filler in the film is also important for arriving at a film that exhibits tremendous functional and mechanical properties including high seal strength.

### Example 1: Composition of a Biaxially Oriented Thermoformable PET Film

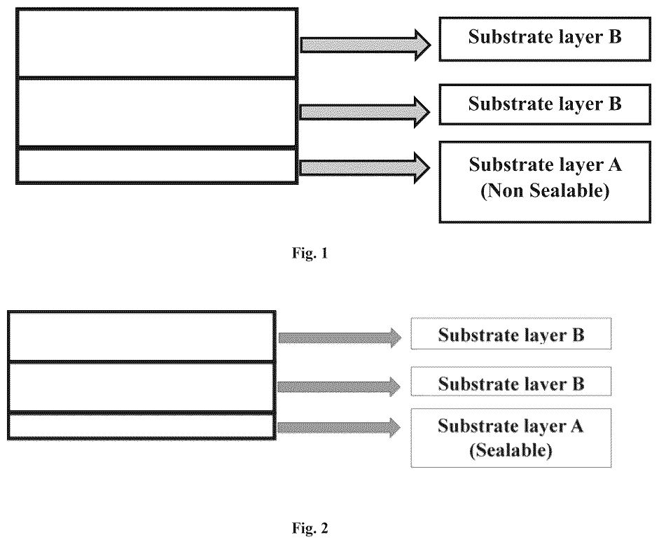

The present example describes the composition of a biaxially oriented thermoformable non-sealable PET film 1 (referred as film 1) of multilayer structure B/B/A based on thermoplastic polyethylene terephthalate, modified polyethylene terephthalate chips, and silica as a filler. FIG. 1 depicts the film 1 and the composition of the film 1 is provided in Table 1 and Table 2 below. The layered structure (B/B) upper layer and middle layer of the film consists of polyethylene terephthalate (PET) chips, modified polyethylene terephthalate chips and 750 ppm of silica as a filler. The thermoplastic polyethylene terephthalate comprises: 73.5% of purified terephthalic acid (PTA)+25% of ethylene glycol (EG)+1.5% of diethylene glycol (DEG) whereas modified polyethylene terephthalate comprises with 71% of PTA+23% of EG+6.0% of DEG. The inner most layer A comprises 1500 ppm of silica and polyethylene terephthalate (PET) comprising 73.5% of PTA+25% of EG+1.5% of DEG.

TABLE 1
Composition of Film 1

| | | | | Weight |
|---|---|---|---|---|
| Film | Structure | | | percentage |
| Grade | Layer | Composition | | (wt. %) |
| B/B/A | Layer B | Silica (Filler) | | 750 ppm |
| Layer | (outer) | PET | Purified | 73.5% |
| (12/23/36μ) | | polymer | terephthalic | |
| | | | acid (PTA) | |
| | | | Ethylene | 25% |
| | | | glycol (EG) | |
| | | | Diethylene | 1.5% |
| | | | glycol (DEG) | |
| | | Modified | PTA | 71% |
| | | PET | EG | 23% |
| | | polymer | DEG | 6% |
| | Layer B | Silica (Filler) | | 750 ppm |
| | (middle) | PET | PTA | 73.5% |
| | | polymer | EG | 25% |
| | | | DEG | 1.5% |
| | | Modified | PTA | 71% |
| | | PET | EG | 23% |
| | | polymer | DEG | 6% |
| | Layer A | Silica (Filler) | | 1500 ppm |
| | (inner) | PET | PTA | 73.5% |
| | | polymer | EG | 25% |
| | | | DEG | 1.5% |

Table 2 shows the total weight percentage of components present with respect to the film 1

| | | | | Total |
|---|---|---|---|---|
| | Layer B | Layer B | Layer A | weight |
| Components | (outer) | (middle) | (inner) | percentage |
| Silica | 0.031875% | 0.031875% | 0.0225% | 0.08625% |
| PET polymer | 23.375% | 23.375% | 14.9775% | 61.7275% |
| Modified PET | 19.09313% | 19.09313% | — | 38.18625% |
| polymer | | | | |

Referring to Table 2, the film 1 of the present invention comprises silica in a weight percentage of 0.086% with respect to the film, PET polymer in a weight percentage of 61.7% with respect to the film, and modified PET polymer in a weight percentage of 38.18% with respect to the film.

### Example 2: Composition of a Biaxially Oriented Thermoformable PET Non-Sealable Film Consisting MBUV

The layered structure (B/B) upper layer and middle layer of the film of the present example consists the same composition as mentioned in example 1. However, the inner most layer A consists of UV resistance master batch (MBUV) polymer comprising PET polymer+18.08% of premix (mixture of UV stabilizer and antioxidant) to prevent the film of the present from ultraviolet (UV) radiation. The CAS No. for UV absorber: (1)018600-59-4, and (2) 2725-22-6, whereas the CAS No. for Antioxidant is: (1) 040601-76-1 and (2) 31570-04-4. The ratio of UV absorber and Antioxidant is 1:1 (i.e., the weight percentage of each UV absorber and antioxidant is 50% each).

The film of the present example is referred to as “film 2 (also depicted in FIG. 1)”, and the composition of the same is provided in Table 3 and Table 4 below.

TABLE 3
Composition of Film 2

| | | | | Weight |
|---|---|---|---|---|
| Film | Structure | | | percentage |
| Grade | Layer | Composition | | (wt. %) |
| B/B/A | Layer B | Silica (Filler) | | 750 ppm |
| Layer | (outer) | PET | Purified | 73.5% |
| (12/23/36μ) | | polymer | terephthalic | |
| | | | acid (PTA) | |
| | | | Ethylene | 25% |
| | | | glycol (EG) | |
| | | | Diethylene | 1.5% |
| | | | glycol (DEG) | |
| | | Modified | PTA | 71% |
| | | PET | EG | 23% |
| | | polymer | DEG | 6% |

| | | |
|---|---|---|
| Layer B | Silica (Filler) | 750 ppm |
| (middle) | | (0.075%) |

| | | |
|---|---|---|
| PET | PTA | 73.5% |
| polymer | EG | 25% |
| | DEG | 1.5% |
| Modified | PTA | 71% |
| PET | EG | 23% |
| polymer | DEG | 6% |

| | | |
|---|---|---|
| Layer A | Silica (Filler) | 1500 ppm |
| (inner) | | (0.15%) |

| | | |
|---|---|---|
| PET | PTA | 73.5% |
| polymer | EG | 25% |
| | DEG | 1.5% |
| MBUV | PET polymer | 81.92% |

| | |
|---|---|
| polymer | Premix (UV absorber + |
| | antioxidant) (18.08%) |

Table 4 shows the total weight percentage of components present with respect to the film 2

| | | | | Total |
|---|---|---|---|---|
| | Layer B | Layer B | Layer A | weight |
| Components | (outer) | (middle) | (inner) | percentage |
| Silica | 0.031875% | 0.031875% | 0.0225% | 0.08625% |
| PET polymer | 23.375% | 23.375% | 13.9275% | 60.6775% |
| Modified | 19.09313% | 19.09313% | — | 38.18625% |
| PET polymer | | | | |
| MBUV polymer | — | | 1.05% | 1.05% |

Referring to Table 4, the film 2 of the present invention comprising silica in a weight percentage of 0.086% with respect to the film, PET polymer in a weight percentage of 60.67% with respect to the film, and modified PET polymer in a weight percentage of 38.18% with respect to the film, and MBUV polymer in the weight percentage of 1.05% with respect to the film.

### Example 3: Composition of a Biaxially Oriented Thermoformable PET Sealable Film Comprising SH3-M Polymer

In the present example, the biaxially oriented formable sealable polyester film prepared by using the sequential biaxial orientation of the extrudate has an B/B/A layer structure film which comprises heat sealable master batch (SH3-M) polymer (which is a blend of PET+Isophthalic Acid (IPA)) in its inner most layer, as a result of the which the film exhibits excellent heat seal strength. The specific composition of the film of the present example (referred to as “Film 3”) is provided in Table 5 and Table 6 below. The structure of the sealable film of the present example is depicted in FIG. 2. The B layer thickness is 85% and the A layer is 15% of the total thickness of the polyester film.

TABLE 5
Composition of Film 3

| | | | | Weight |
|---|---|---|---|---|
| Film | Structure | | | percentage |
| Grade | Layer | Composition | | (wt. %) |
| B/B/A | Layer B | Silica (Filler) | | 750 ppm |
| Layer | (outer) | PET | Purified | 73.5% |
| (12/23/36μ) | | polymer | terephthalic | |
| | | | acid (PTA) | |
| | | | Ethylene | 25% |
| | | | glycol (EG) | |
| | | | Diethylene | 1.5% |
| | | | glycol (DEG) | |
| | | Modified | PTA | 71% |
| | | PET | EG | 23% |
| | | polymer | DEG | 6% |
| | Layer B | Silica (Filler) | | 750 ppm |
| | (middle) | | | (0.075%) |
| | | PET | PTA | 73.5% |
| | | polymer | EG | 25% |
| | | | DEG | 1.5% |
| | | Modified | PTA | 71% |
| | | PET | EG | 23% |
| | | polymer | DEG | 6% |
| | Layer A | SH3-M | PET | 78% |
| | (inner) | | Isophthalic | 22% |
| | | | Acid (IPA) | |

Table 6 shows the total weight percentage of components present with respect to the film 3

| | | | | Total |
|---|---|---|---|---|
| | Layer B | Layer B | Layer A | weight |
| Components | (outer) | (middle) | (inner) | percentage |
| Silica | 0.031875% | 0.031875% | — | 0.06375% |
| PET polymer | 23.375% | 23.375% | — | 46.75% |
| Modified | 19.09313% | 19.09313% | — | 38.18625% |
| PET polymer | | | | |
| SH3M polymer | — | | 15% | 15% |

Referring to Table 6, the film 3 of the present invention comprises silica in a weight percentage of 0.063% with respect to the film, PET polymer in a weight percentage of 46.75% with respect to the film, and modified PET polymer in a weight percentage of 38. 18% with respect to the film, and SH3M polymer in the weight percentage of 15% with respect to the film.

### Example 4: Manufacturing Process for Biaxially Oriented Formable Polyester Film

The biaxially oriented formable polyester film of B/B/A layer structure having different thickness (such as 12 μ, 23 μ or 36 μ) were prepared based on the different compositions as described in the examples 1, 2 and 3 of the present invention. The biaxially oriented formable polyester films of the present invention were prepared via a conventional sequential biaxial orientation machine having a single screw mainline extrusion and a twin screw sub extrusion process.

The detailed process used for preparing the biaxially oriented formable polyester films of examples 1 and 2 of the present invention are provided below:
(a) Thermoplastic polyethylene terephthalate (PET) and modified PET pellets in combination with silica (filler) having a desired properties, were fed into the main extrusion line at a temperature of 265° C. to obtain a first mixture;
(b) A blend of standard PET pellets, and silica as filler (as in case of example 1), or a blend of standard PET pellets, silica as filler, and MBUV polymer (as in case of example 2) were fed into the sub-extrusion process at a temperature of 274° C. to obtain a second mixture. The steps (a) and (b) of the extrusion process allowed the materials to melt separately.
(c) The first mixture of step (a) and second mixture of step (b) were laminated together in a feed-block to produce a laminated moltenstructure in an extrusion die.
(d) The laminated desired molten structure of step (c) (e.g. an B/B/A PET sheet) extruded from the extrusion slit die was quenched with the help of a chilled casting drum to produce a thick and amorphous film having multilayered structure as B/B/A.
(e) The amorphous film of step (d) was then subsequently stretched in the longitudinal direction (MD), or in length direction axis of the film to produce a longitudinal (MD) oriented film, utilizing a motorized heater roller train at a temperature range of 86° C. with stretching ratio of less than 3.
(f) The longitudinal oriented film of step (e) ware stretched in the transverse direction (TD) with a chain driven system transverse direction orientation (TDO) at a stretching temperature range of 110-190° C.; with TDO stretching ratio of less than 3, to prepare the biaxially oriented film of the present invention.

Table 7 discloses the exemplary processing parameters used to produce the formable flexible PET film of the examples 1 and 2.

TABLE 7
Processing parameters of thermoformable PET films of Examples 1 and 2.
Processing Parameters of Thermoformable PET Film (Non Sealable)

| | | | | |
|---|---|---|---|---|
| Example | Main | Bright PET: 55%: | Bright PET: 55%: | Bright PET: 55%: |
| 1 and 2 | Feeding | Modified PET: 44.925%: | Modified PET: 44.925%: | Modified PET: 44.925%: |
| | | Silica: 0.075% | Silica: 0.075% | Silica: 0.075% |
| | Co-ex | Bright PET: 99.85%: | Bright PET: 92.85%:: | Bright PET: 92.85%:: |
| | Feeding | Silica 0.15% | Silica: 0.15% | Silica: 0.15% |
| | | | MBUV: 07% | MBUV: 07% |

Processing Parameters

| Thickness (μ) | 12 | | 23 | | 36 | |
|---|---|---|---|---|---|---|
| Main Throughput (Kg/hr) | 1750-2100 | | 2500-2700 | | 2500-2700 | |
| Co-ex Throughput (Kg/Hr) | 350 | | 350 | | 350 | |
| Total Throughput (Kg/hr) | 2100-2450 | | 2850-3050 | | 2850-3050 | |
| Main Extrusion Temp (° C.) | 255-274° | C. | 255-278° | C. | 255-278° | C. |
| Co-Extrusion Temp (° C.) | 265-280° | C. | 265-280° | C. | 265-280° | C. |
| Die Temp (° C.) | 275° | C. | 278° | C. | 278° | C. |
| Chill roll Speed (m/min) | 113-116 | | 80-90 | | 50-60 | |
| MDR-1st Draw Ratio (%) | ≤1.03 | | 1.01 | | 1.01 | |
| MDR-2nd Draw Ratio (%) | ≤3.1 | | ≤3.0 | | ≤3.0 | |
| MDO Preheating zone | 74-83° | C. | 74-83° | C. | 74-83° | C. |
| Temperature (° C.) | | | | | | |
| MDO Stretching zone | 86° | C. | 86° | C. | 88° | C. |
| Temperature (° C.) | | | | | | |
| MDO Cooling zone | 30-32° | C. | 30-32° | C. | 30-32° | C. |
| Temperature (° C.) | | | | | | |
| TDO Preheating zone | 102-104° | C. | 100-104° | C. | 100-104° | C. |
| Temperature (° C.) | | | | | | |
| TDO Stretching zone | 112-190° | C. | 112-185° | C. | 112-185° | C. |
| Temperature (° C.) | | | | | | |
| TDO Crystallizing zone | 240° | C. | 236° | C. | 236° | C. |
| Temperature (° C.) | | | | | | |
| TDO Cooling zone | 65-80° | C. | 65-80° | C. | 65-80° | C. |
| Temperature (° C.) | | | | | | |

| | | | |
|---|---|---|---|
| TDO Draw ratio (%) | 3.40% | 3.31% | 3.29% |
| Relaxation % | 0.90% | 0.90% | 0.90% |

Further, the detailed process used for preparing the biaxially oriented formable polyester films of example 3 of the present invention is provided below:
a) Thermoplastic polyethylene terephthalate (PET) and modified PET pellets in combination with silica (filler) having a desired properties, were fed into the main extrusion line at a temperature in the range of 255-278° C. to obtain a first mixture;
(b) A SH3-polymer (a blend of standard PET pellets, and IPA polymer) was fed into the sub- extrusion process at a temperature of 274-275° C. to obtain a second mixture. The steps (a) and (b) of the extrusion process allowed the materials to melt separately.
(c) The first mixture of step (a) and second mixture of step (b) were laminated together in a feed-block to produce a laminated moltenstructure in an extrusion die.
(d) The laminated desired molten structure of step (c) (e.g. an B/B/A PET sheet) extruded from the extrusion slit die was quenched with the help of a chilled casting drum to produce a thick and amorphous film having multilayered structure as B/B/A.
(e) The amorphous film of step (d) was then subsequently stretched in the longitudinal direction (MD), or in length direction axis of the film to produce a longitudinal (MD) oriented film, utilizing a motorized heater roller train at a temperature of 86° C. to 88° C. with stretching ratio of less than 3.1.
(f) The longitudinal oriented film of step (e) ware stretched in the transverse direction (TD) with a chain driven system transverse direction orientation (TDO) at a stretching temperature range of 112-190° C.; with TDO stretching ratio in the range of 3.25-3.45%, to prepare the biaxially oriented film of the present invention.

TABLE 8
discloses the exemplary processing parameters used to produce the formable sealable
flexible PET film of example 3.
Processing Parameters of formable sealable PET Films

| | | | |
|---|---|---|---|
| Main | Bright PET: 55%: | Bright PET: 55%: | Bright PET: 55%: |
| Feeding | Modified PET: 44.925%: | Modified PET: 44.925%: | Modified PET: 44.925%: |
| | Silica: 0.075% | Silica: 0.075% | Silica: 0.075% |
| Co-ex | SH3-M: 100% | SH3-M: 100% | SH3-M: 100% |
| Feeding | | | |

Processing Parameters

| Thickness (μ) | 12 | | 23 | | 36 | |
|---|---|---|---|---|---|---|
| Main Throughput (Kg/hr) | 1750-2100 | | 2000-2200 | | 2000-2200 | |
| Co-ex Throughput (Kg/Hr) | 350 | | 350-380 | | 350-380 | |
| Total Throughput (Kg/hr) | 2100-2450 | | 2350-2580 | | 2350-2580 | |
| Main Extrusion | 255-274° | C. | 255-278° | C. | 255-278° | C. |
| Temp (° C.) | | | | | | |
| Co-Extrusion | 260-270° | C. | 260-270° | C. | 260-270° | C. |
| Temp (° C.) | | | | | | |
| Die Temp (° C.) | 275° | C. | 278° | C. | 278° | C. |
| Chill roll | 113-116 | | 70-80 | | 44-50 | |
| Speed (m/min) | | | | | | |
| MDR-1st Draw | 1.01 | | 1.01 | | 1.01 | |
| Ratio (%) | | | | | | |
| MDR-2nd Draw | ≤3.1 | | ≤3.1 | | ≤3.1 | |
| Ratio (%) | | | | | | |
| MDO Preheating zone | 74-83° | C. | 74-83° | C. | 74-83° | C. |
| Temperature (° C.) | | | | | | |
| MDO Stretching zone | 86° | C. | 86° | C. | 86° | C. |
| Temperature (° C.) | | | | | | |
| MDO Cooling zone | 30-32° | C. | 30-32° | C. | 30-32° | C. |
| Temperature (° C.) | | | | | | |
| TDO Preheating zone | 100-104° | C. | 100-104° | C. | 100-104° | C. |
| Temperature (° C.) | | | | | | |
| TDO Stretching zone | 112-175° | C. | 112-175° | C. | 112-175° | C. |
| Temperature (° C.) | | | | | | |
| TDO Crystallizing | 228° | C. | 228° | C. | 228° | C. |
| zone Temperature | | | | | | |
| (° C.) | | | | | | |
| TDO Cooling zone | 65-80° | C. | 65-80° | C. | 65-80° | C. |
| Temperature (° C.) | | | | | | |

| | | | |
|---|---|---|---|
| TDO Draw ratio (%) | 3.25-3.45% | 3.25-3.45% | 3.25-3.45% |
| Relaxation % | 0.9-1.0% | 0.9-1.0% | 0.9-1.0% |

The films of examples 1 to 3, can be oriented by any usual method, such as the roll stretching method, the long-gap stretching method, the tenter stretching method, and the tubular stretching method. With use of any of these methods, it is possible to conduct biaxial stretching in succession, simultaneous biaxial stretching, uniaxial stretching, or a combination of these. With the biaxial stretching mentioned above, stretching in the machine direction and transverse direction can be done at the same time. Also, the stretching can be done first in one direction and then in the other direction to result in effective biaxial stretching. The stretching of the films can also be done by preliminarily heating the films at a temperature in the range of 5° C. to 80° C., i.e., above their glass transition temperature.

### Example 5: Properties of Biaxially Oriented Formable Sealable Polyester Film

The biaxially oriented formable polyester films of examples 1, 2, and 3 were evaluated based on different parameters such as dart impact, carboxylic end group analysis, intrinsic viscosity, oligomer content, DEG content and thermal characterization such as glass transition temperature.

The Tg (glass transition temperature and Tm (melting temperature) of the films of the Examples 1 to 3 were studied using Differential Scanning calorimeter (DSC-4000 Perkin Elmer). The first exothermic peak was observed in the range of 74-85° C. and an endothermic peak was observed in the temperature range of −260° C. The glass transition temperature of the films were observed in the range of 77-82° C. and melting temperature was observed in the range of 240-260° C.

Falling dart impact strength or toughness of the films were evaluated by using drop dart impact tester as per ASTM D1709. This test uses a single dart configuration and a single drop height, while varying the weight of the dart. In this, the test specimen is clamped securely in a pneumatic ring at the base of the drop tower. The mounting bracket is adjusted to an appropriate drop height, and the dart is inserted into the bracket. The dart is released to drop onto the center of the test specimen. The drop weight and the test result (pass/fail) are recorded. There are two methods (method A and method B) available for recording dart impact strength or toughness. The test method A specifies a dart with a 38 mm (1.5″) diameter dropped from 0.66 m (26″) Test method B specifies a dart with a 51 mm (2″) diameter dropped from 1.5 m (60″). In the present invention, Method A was used and a series of 20 to 25 impacts were conducted. The results from these impacts are used to calculate the impact failure weight, which intends to mean the point at which 50% of the test specimens would fail under the impact.

The puncture resistance of the films of the present invention were studied using standard ASTM F1306-16 for slow rate penetration resistance of flexible films and laminate. Penetration resistance is a vital part of the quality of thin, flexible materials in which any sharp-edged item pointed downward will not break past the barrier of a film or laminate. ASTM F1306 is a specification regarding the slow rate penetration resistance properties of flexible barrier films and laminates. Thin, flexible specimens must be of uniform thickness at 0.0025 mm or 0.0001 inch. For this purpose, a universal testing machine with a recording device and penetration probe were used to perform this test. Ultimately, the force, energy, and elongation to perforation of the material were observed.

The parameters like Carboxylic end group analysis, intrinsic viscosity, oligomer content, DEG content and thermal characterization such as Glass transition temperature and Melting temperature values of the compositions as mentioned in Table 9.

TABLE 9
Analysis of films of the present invention based on different parameters
Analysis of Films of the present invention

| | | | Film 1 | Film 2 | Film 3 |
|---|---|---|---|---|---|
| S. No. | Parameters | Unit | (Example 1) | (Example 2) | (Example 3) |
| 1 | Intrinsic viscosity (I V) | dl/g | 0.618 | 0.613 | 0.605 |
| 2 | —COOH | meq/kg | 35 | 35 | 35 |
| 3 | % ASH | wt. % | 0.065 | 0.062 | 0.068 |
| 4 | Oligomer content | wt. % | 1.16 | 1.23 | 1.22 |
| 5 | DEG content | wt. % | 3.17 | 3.22 | 3.26 |
| 6 | Glass temperature (Tg) | ° C. | 78.5 | 78.7 | 78.2 |
| 7 | Melting temperature | ° C. | 247.8 | 247.3 | 246.9 |

Further, the properties of the biaxially oriented formable polyester film of B/B/A multilayer structure having different thickness (such as 12, 23 and 36μ) were evaluated based on different parameters as mentioned in Table 10 below.

TABLE 10
Properties of biaxially oriented formable polyester films

| | | | Example 1 | | | Example 2 | | | Example 3 | | |
|---|---|---|---|---|---|---|---|---|---|---|---|
| S. No. | PARAMETERS | Unit | 12 | 23 | 36 | 12 | 23 | 36 | 12 | 23 | 36 |
| 1. | DART IMPACT (ASTM D1709) | | | | | | | | | | |
| | Unbreakable | gf | 220 | 450 | 850 | 222 | 460 | 890 | 230 | 472 | 870 |
| | Breakable | gf | 240 | 470 | 900 | 245 | 475 | 903 | 240 | 470 | 930 |
| 2. | Tensile strength (ASTM D-882 ) | | | | | | | | | | |
| | MD | kg/cm² | 1304 | 1460 | 1500 | 1310 | 1465 | 1532 | 1298 | 1455 | 1498 |
| | TD | kg/cm² | 1543 | 1630 | 1750 | 1540 | 1645 | 1763 | 1520 | 1610 | 1725 |
| 3. | Elongation (ASTM D-882) | | | | | | | | | | |
| | MD | % | 146 | 186 | 192 | 144 | 181 | 187 | 152 | 193 | 198 |
| | TD | % | 132 | 165 | 164 | 130 | 163 | 168 | 137 | 169 | 172 |
| 4. | Puncture | N | 5.8 | 6.2 | 7.0 | 6.2 | 6.5 | 7.1 | 6.3 | 6.9 | 7.5 |
| | Resistance | | | | | | | | | | |
| | (ASTM | | | | | | | | | | |
| | F1306) | | | | | | | | | | |

Seal initiation temperature and Seal strength
(Films which were made from Example 3 are only sealable)

| 5. | Seal | ° C. | NA | NA | NA | NA | NA | NA | 90 | 100 | 100 |
|---|---|---|---|---|---|---|---|---|---|---|---|
| | initiation | | | | | | | | | | |
| | temperature | | | | | | | | | | |
| 6. | Seal | kg/cm² | NA | NA | NA | NA | NA | NA | 1.0-1.1 | 1.0-1.4 | 1.0-1.5 |
| | Strength | | | | | | | | | | |
| | 180° C., 1 | | | | | | | | | | |
| | Second @ 4 | | | | | | | | | | |
| | kg/cm² | | | | | | | | | | |
| | Pressure | | | | | | | | | | |
| 7. | Shrinkage @ 150° C. and 30 minutes (ASTM D-1204) | | | | | | | | | | |
| | MD | % | 2.0 | 2.0 | 2.0 | 2.0 | 2.0 | 2.0 | 2.0 | 2.0 | 2.0 |
| | TD | % | 2.0 | 2.0 | 2.0 | 2.0 | 2.0 | 2.0 | 2.0 | 2.0 | 2.0 |

From Table 10, it can be inferred that the biaxially oriented formable polyester film of B/B/A multilayer structure having outer and the middle layer B comprising at least one filler, at least one thermoplastic polyethylene terephthalate (PET) polymer, and at least one modified thermoplastic polyethylene terephthalate (PET) polymer and inner layer A comprising at least one component selected from the group consisting of at least one filler, at least one thermoplastic polyethylene terephthalate (PET) polymer, MBUV polymer, SH3-M polymer, and combination thereof, exhibits following properties: (a) High dart impact resistance property in the range of 200-850 gf; (b) Better puncture resistance, i.e., greater than 4.5N; (c) High seal strength (0.8-1.4 kg/cm²) with low seal initiation temperature (90° C.-100° C.); (d) Elongation % in longitudinal direction in the range of 140 to 200 and in transverse direction in the range of 130 to 180.

Further, the thermoformable film having the properties of tensile strength, elongation, dart impact and puncture resistance and thermal properties like seal initiation temperature, are comparative to all three films of examples 1 to 3, as shown above. Thus, all three films shows cold forming and thermoforming properties.

Overall, it can be inferred from Tables 9 and 10 that the technical properties of the films of the present invention are due to the presence of modified thermoplastic polyethylene terephthalate (PET) polymer in layer B, and fillers like silica present in inner layer A, outer and middle layer B.

### Example 6: Comparative Examples

The present example demonstrates the comparison between the biaxially orientated sealable film of the present invention and the conventional films known in the art. Table 11 shows the comparison of oxygen and water transmission rate between the conventional films and working films of the pre sent invention. Water Vapour Transmission Rate (WVTR) or Moisture Vapour Transmission Rate (MVTR) is the rate at which water vapour permeate through solid material over a specific period of time. OTR—Oxygen transmission rate (OTR) is the rate at which oxygen molecules traverse through a solid material over a given time period.

TABLE 11
Comparison of oxygen transmission rate (OTR) and water
vapour transmission rate (WVTR) between the conventional
films and working films of the present invention.

| Type of Barrier | | | | | |
|---|---|---|---|---|---|
| WVTR gm/m²/day | | | OTR CC/m²/day | | |
| Film Thickness (prepared as per Example 1) (μm) | | | | | |
| 12 | 23 | 36 | 12 | 23 | 36 |

Plain Film (Without Barrier Coating)

| | | | | | | |
|---|---|---|---|---|---|---|
| Results | 45 | 32 | 28.6 | 157 | 142 | 114 |

PVDC Coated Film (Without Cavity Draw)

| | | | | | | |
|---|---|---|---|---|---|---|
| Results | 7.6 | 7.1 | 6.2 | 9.2 | 8.6 | 7.1 |

Coated cold formed film
(After 10 mm cavity Draw)

| | | | | | | |
|---|---|---|---|---|---|---|
| Results | 8.32 | 7.21 | 6.2 | 12.4 | 11.6 | 10.3 |

The plain film as mentioned in Table 11 are film without barrier coated films that can be prepared from any of three examples of the present invention. The polyvinylidene chloride (PVDC) coated films are inline/offline coated films that are able to provide high oxygen and moisture barrier. Further, the cold formed films are films in which cavity is drawn in cold conditions (i.e., without any heating).

It is also pertinent to note that the presence of modified PET polymer is crucial for arriving at the film of the present invention that exhibits better functional and mechanical properties, as compared to the conventional biaxially oriented film having A/B/A structure, or Biaxially Oriented Poly Propylene Films/Polyethylene film/Cast Polypropylene Films (BOPP/BOPA/PE/CPP), or the like. Moreover, the presence of fillers (like silica) in all three layers, i.e., outer and middle layer B and inner layer A, is equally important for arriving at a biaxially orientated formable film of the present invention. The absence of or replacement of modified PET polymer and filler with any other material, would not result in the film with desired functional and/or mechanical properties. Particularly, the films in which filler is absent may increase the coefficient of friction and roll opening is not easy. Further, in absence of modified PET polymer, structural strength and functions properties of the film are affected.

For instance, the presence of modified PET polymer is important for arriving at the film having drawability in the range of 10 to 17 mm, and which exhibits better structural and functional properties. The effect of the presence of the modified PET polymer is demonstrated in table 12 below.

TABLE 12
Effect of presence of the modified PET polymer in film

| | | | Film 1 | | | Film 2 | | |
|---|---|---|---|---|---|---|---|---|
| | | | (Example 1) | | | (Example 2) | | |
| S. No. | PARAMETERS | Unit | 12 | 23 | 36 | 12 | 23 | 36 |
| 1. | DART IMPACT (ASTM D1709) | | | | | | | |
| | Unbreakable | gf | 220 | 450 | 850 | 222 | 460 | 890 |
| | Breakable | gf | 240 | 470 | 900 | 245 | 475 | 903 |
| 2. | Tensile strength (ASTM D-882) | | | | | | | |
| | MD | kg/cm² | 1304 | 1460 | 1500 | 1310 | 1465 | 1532 |
| | TD | kg/cm² | 1543 | 1630 | 1750 | 1540 | 1645 | 1763 |
| 3. | Elongation (ASTM D-882) | | | | | | | |
| | MD | % | 146 | 186 | 192 | 144 | 181 | 187 |
| | TD | % | 132 | 165 | 164 | 130 | 163 | 168 |
| 4. | Puncture | N | 5.8 | 6.2 | 7 | 6.2 | 6.5 | 7.1 |
| | Resistance | | | | | | | |
| | (ASTM F1306) | | | | | | | |
| 5. | Drawability | mm | 12.36 | 14.89 | 16.78 | 11.8 | 14.62 | 16.3 |
| | (Cold Draw) | | | | | | | |

| | Film 3 | | | TF PET without | | |
|---|---|---|---|---|---|---|
| | (Example 3) | | | modified PET Polymer | | |
| S. No. | 12 | 23 | 36 | 12 | 23 | 36 |

| | |
|---|---|
| 1. | DART IMPACT (ASTM D1709) |

| | | | | | |
|---|---|---|---|---|---|
| 230 | 472 | 870 | 140 | 280 | 350 |
| 240 | 470 | 930 | 155 | 300 | 370 |

| | |
|---|---|
| 2. | Tensile strength (ASTM D-882) |

| | | | | | |
|---|---|---|---|---|---|
| 1298 | 1455 | 1498 | 2317 | 2222 | 1981 |
| 1520 | 1610 | 1725 | 2335 | 2893 | 2378 |

| | |
|---|---|
| 3. | Elongation (ASTM D-882) |

| | | | | | | |
|---|---|---|---|---|---|---|
| | 152 | 193 | 198 | 116 | 118 | 156 |
| | 137 | 169 | 172 | 98 | 96 | 131 |
| 4. | 6.3 | 6.9 | 7.5 | 6.3 | 10.32 | 13.14 |
| 5. | 12.42 | 13.95 | 16.51 | 5.6 (failed) | 7.1(failed) | 8.3 (failed) |

Referring to Table 12, it can be inferred that the presence of the modified PET polymer is crucial for arriving at the films (film 1, film 2, and film 3) that exhibits drawability in the range of 10 to 17 mm. The absence of modified PET polymer (as in the case of TF PET polymer without modified PET polymer) results in a film that has a drawability less than 10 mm, and hence it is considered as a non-working film.

### Example 7: Application of the Film of the Present Invention

The biaxially orientated sealable film of the present invention are used for various packaging pharma—packaging application, more particularly, blister packaging such as for capsules, tablets, ideal for deli meats, cuts of meat, poultry or fish, or dry products such as wrappers, fresh proteins, frozen foods, sliced cheese packaging ideal for syringes, tablet packaging, dental kits and more as such or in laminate structure. The film of the present invention are also use full for single layer sustainable packaging or manufacturing sustainable recyclable laminate with another polyester film.

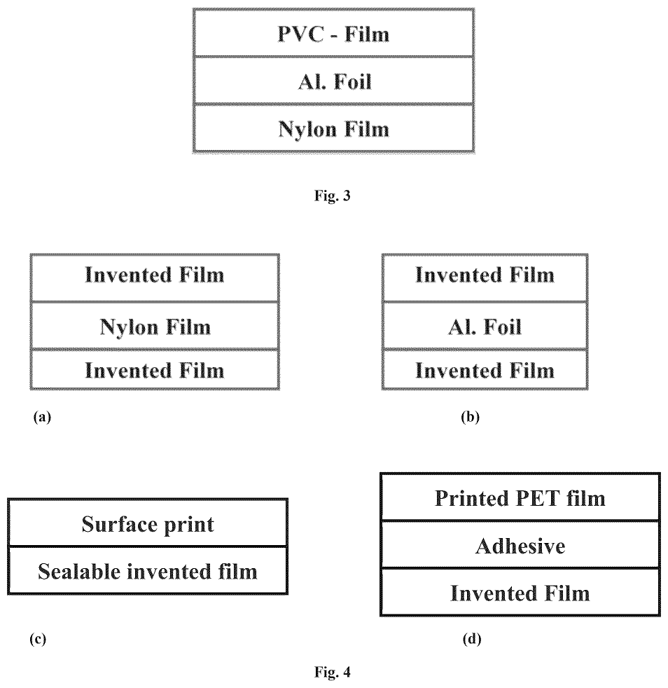

The present example utilizes the biaxially orientated sealable film of the present invention to prepare laminated structure which are further used for laminate packaging materials. FIG. 4 shows various type of the laminate structure comprising the biaxially orientated sealable film (as obtained in Example 3) of the present invention. FIG. 4(a) shows a laminate structure comprising a nylon film sandwiched between the biaxially-oriented polyester film of the present invention. FIG. 4(b) shows an aluminum foil sandwiched between the biaxially-oriented sealable polyester film of the present invention. FIG. 4(c) Shows mono family mono layer sustainable structure and FIG. 4(d) Sustainable mono-family multilayer laminate. The laminate comprising the film of the present invention exhibits high mechanical strength (e.g. Tensile, toughness and elongation), high seal strength, improved barrier properties, better optical properties, balanced shrinkage at elevated temperature in longitudinal and machine directions, high temperature dimensional stability, puncture resistance, dart impact strength, as compared to the multilayered films or conventional films sealable BOPP, PE, or films employing PVC, PS, PP, and especially PC. FIG. 3 depicts the films conventionally known in the prior arts.

### ADVANTAGES OF THE PRESENT INVENTION

The present invention discloses a biaxially oriented sealable and non-sealable polyester film of multilayer structure B/B/A comprising: (a) an outer layer B; (b) a middle layer B; and (c) an inner layer A, wherein the outer and the middle layer B comprises at least one filler, at least one thermoplastic polyethylene terephthalate (PET) polymer, and at least one modified thermoplastic polyethylene terephthalate (PET) polymer, and wherein the inner layer A comprises at least one component selected from the group consisting of at least one filler, at least one thermoplastic polyethylene terephthalate (PET) polymer, MBUV polymer, SH3-M polymer, and combination thereof. The present invention also discloses a cost-effective process for preparing the biaxially oriented polyester film of multilayer structure B/B/A as comprised herein.

The key advantages of the biaxially oriented sealable and non-sealable polyester film of the present invention are:
(a) It exhibits good cold and thermoformability abilities and also exhibits superior barrier after formation and heat sealability properties
(b) It has a high seal strength in the range of 0.8-1.4 kg/cm² with low seal initiation temperature 90° C.
(c) It also exhibits brilliant optical properties in particular a high clarity and also has a better puncture resistant.
(d) It has a thickness in the range of 8 μ to 75 μ.

(e) It has good barrier properties, particularly with respect to aroma, oxygen, and water vapour.
(f) The film also has excellence elongation properties in longitudinal direction (MD) and transverse direction (TD), which is in the range of 140 to 200 and 130 to 180, respectively.
(g) Apart from the above properties, the film has the following properties as well: (i) excellence dart impact resistance (means having ability to absorb shock with high magnitude) in the range of 220-850 gf; (ii) Puncture resistance in the range of 6-9 N; (iii) Glass and melting temperature (Tg) and (Tm) value of 78.2-78.7 and 246.9-247.8, respectively; (iv) Seal initiation temperature in the range of 90-100° C.; and (v) Drawability in the range of 10-17 mm.
(h) The film of the present invention is characterized with a high-transparency has a low degree of filling (i.e., less concentration of anti-blocking agent), wherein the filler allows easy roll opening and provide better coefficient of friction, as a result of which the film of the present invention has good winding and processing qualities.
(i) The film of the present invention can be recycled without contaminating the environment, and the said film is produced from the recycled or virgin material.
(j) The film is particularly useful for pharma-packaging application, more particularly, blister packaging such as for capsules, tablets, ideal for deli meats, cuts of meat, poultry or fish, or dry products such as wrappers, fresh proteins, frozen foods, sliced cheese packaging ideal for syringes, tablet packaging, dental kits and more as such or in laminate structure.
(j) The film of the present invention is produced from an economical process.

1. A biaxially oriented sealable and non-sealable polyester film of multilayer structure B/B/A comprising:
a) an outer layer B;
b) a middle layer B; and
c) an inner layer A,
wherein the outer and the middle layer B comprises at least one filler, at least one thermoplastic polyethylene terephthalate (PET) polymer, and at least one modified thermoplastic polyethylene terephthalate (PET) polymer, and
wherein the inner layer A comprises at least one component selected from the group consisting of at least one filler, at least one thermoplastic polyethylene terephthalate (PET) polymer, UV resistance master batch (MBUV) polymer, heat sealable master batch (SH3-M) polymer, and combination thereof.

2. The biaxially orientated sealable and non-sealable film as claimed in claim 1, wherein the thermoplastic polyethylene terephthalate (PET) polymer having a combined weight percentage in the range of 55 to 75% with respect to the film.

3. The biaxially orientated sealable and non-sealable film as claimed in claim 1, wherein the modified PET polymer has a weight percentage in the range of 30 to 45% with respect to the film.

4. The biaxially orientated sealable and non-sealable film as claimed in claim 1, wherein the filler having a combined weight percentage in the range of 0.03 to 0.08% is selected from silica.

5. The biaxially orientated sealable and non-sealable film as claimed in claim 1, wherein the MBUV polymer having a weight percentage in the range of 0.5 to 2% with respect to the film, comprises PET polymer, UV absorber, and antioxidant.

6. The biaxially orientated sealable and non-sealable film as claimed in claim 1, wherein SH3-M polymer having a weight percentage in the range of 10 to 30%, comprises PET polymer and isophthalic acid (IPA).

7. The biaxially orientated sealable and non-sealable film as claimed in claim 1, wherein the thermoplastic polyethylene terephthalate (PET) polymer comprises:
a) 70 to 80% of purified terephthalic acid (PTA);
b) 20 to 30% of ethylene glycol (EG); and
c) 1 to 2% of diethylene glycol (DEG).

8. The biaxially orientated sealable and non-sealable film as claimed in claim 1, wherein the modified PET polymer comprises:
a) 65 to 85% of purified terephthalic acid (PTA);
b) 20 to 30% of ethylene glycol (EG); and
c) 4 to 10% of diethylene glycol (DEG).

9. The biaxially orientated sealable and non-sealable film as claimed in anyone of the claims 1 to 8, wherein the film has a thickness in the range of 8 to 75 μ.

10. The biaxially oriented sealable and non-sealable film as claimed in anyone of the claims 1 to 8, wherein the film has a percentage of elongation in the range of 140 to 200 and 130 to 180 in longitudinal direction and transverse direction, respectively, and wherein the film has a high seal strength in the range of 0.8 to 1.4 kg/cm² with low seal initiation temperature in the range of 90° C.-100° C., and wherein the film has a drawability in the range of 10 to 17 mm.

11. A process for preparing a biaxially oriented sealable and non-sealable film as claimed in anyone of the claims 1 to 10, said process comprising:
a) feeding at least one filler, at least one thermoplastic polyethylene terephthalate (PET) polymer, at least one modified thermoplastic polyethylene terephthalate (PET) polymer into an extruder at a temperature in the range of 255-278° C. to obtain a first mixture;
b) co-feeding at least one member into a co-extruder at a temperature in the 265-280° C. to obtain a second mixture, wherein the at least one member is selected from the group consisting of at least one filler, at least one thermoplastic polyethylene terephthalate (PET) polymer, MBUV polymer, SH3-M polymer, and combination thereof;
c) laminating the first mixture of step (a) and the second mixture of step (b) in an extrusion die to produce a laminated molten structure;
d) extruding the laminated molten structure of step (c) from the extrusion die, followed by its quenching to produce a film having multilayered structure as B/B/A;
e) stretching the film of step (d) in longitudinal direction at a temperature in the range of 80-95° C. to produce a longitudinal oriented film; and
f) stretching the longitudinal oriented film of step (e) in transverse direction at a temperature in the range of 110-190° C. to prepare the biaxially oriented film.

12. An article comprising a biaxially oriented sealable and non-sealable film as claimed in anyone of the claims 1 to 10, wherein the article is selected from the group consisting of sustainable recyclable laminates pouches, packaging material for pharma—packaging application, and blister packaging application.
